(19) United States
(12) Patent Application Publication
(10) Pub. No.: US 2023/0387792 A1
(43) Pub. Date: Nov. 30, 2023

(54) AC-VOLTAGE SENSOR CIRCUIT, PFC CIRCUIT, AND POWER SUPPLY CIRCUIT

(71) Applicant: SHARP KABUSHIKI KAISHA, Sakai City (JP)

(72) Inventors: TAKESHI SHIOMI, Sakai City (JP); KENTARO KISHIRA, Sakai City (JP)

(21) Appl. No.: 18/202,908

(22) Filed: May 27, 2023

(30) Foreign Application Priority Data
May 30, 2022 (JP) 2022-087814

(51) Int. Cl. H02M 1/42; H02M 1/08

(52) U.S. Cl. CPC H02M 1/4208; H02M 1/08; H02M 3/24

(57) ABSTRACT

An AC-voltage sensor circuit is connected to an AC input unit of a PFC circuit. A control circuit and the PFC circuit are isolation-connected. The AC-voltage sensor circuit includes a sense-signal isolation circuit. The PFC circuit and the control circuit are isolation-connected together by the AC-voltage sensor circuit. The AC input unit includes a first line and a second line that are power supply lines. The PFC circuit includes a reference-voltage node. The AC-voltage sensor circuit is configured to output a signal indicating a voltage difference between a “voltage of the first line for the reference-voltage node” and a “voltage of the second line for the reference-voltage node”.

### CROSS-REFERENCE TO RELATED APPLICATIONS

This application claims the benefit of priority to Japanese Patent Application Number 2022-087814 filed on May 30, 2022. The entire contents of the above-identified application are hereby incorporated by reference.

### BACKGROUND

### 1. Field

The following disclosure relates to an AC-voltage sensor circuit, a PFC circuit, and a power supply circuit.

### 2. Description of the Related Art

A power supply circuit to which alternating current (AC) is input requires a sensor circuit for detecting AC voltage that is input to the power supply circuit. Japanese Unexamined Patent Application Publication No. 2019-176642 discloses one example.

### SUMMARY

However, even using such an AC-voltage sensor circuit still has room for improvement.

One aspect of the present disclosure aims to offer an AC-voltage sensor circuit, a PFC circuit, and a power supply circuit that are simpler in circuit configuration than before.

To solve the above problem, an AC-voltage sensor circuit according to one aspect of the present disclosure is an AC-voltage sensor circuit connected to an AC input unit of a PFC circuit. A control circuit and the PFC circuit are isolation-connected. The AC-voltage sensor circuit includes a sense-signal isolation circuit. The PFC circuit and the control circuit are isolation-connected together by the AC-voltage sensor circuit. The AC input unit includes a first line and a second line that are power supply lines. The PFC circuit includes a reference-voltage node. The AC-voltage sensor circuit is configured to output a signal indicating a voltage difference between a “voltage of the first line for the reference-voltage node” and a “voltage of the second line for the reference-voltage node”.

A PFC circuit according to one aspect of the present disclosure is a PFC circuit including the AC-voltage sensor circuit. A gate driving circuit including a drive-signal isolation circuit is connected to the PFC circuit. The gate driving circuit is partly connected to the reference-voltage node. The PFC circuit and the control circuit are isolation-connected together by the gate driving circuit.

Furthermore, a power supply circuit according to one aspect of the present disclosure is a power supply circuit including the PFC circuit. The power supply circuit further includes the following: an isolated DC-DC converter; a DC output unit; an isolated circuit; and a non-isolated circuit. The isolated DC-DC converter includes a primary circuit and a secondary circuit. The AC input unit, the PFC circuit, the primary circuit, the secondary circuit and the DC output unit are connected sequentially from the input of the power supply of the power supply circuit toward the output of the power supply of the power supply circuit. The primary circuit is connected to the control circuit via the isolated circuit. The secondary circuit is connected to the control circuit via the non-isolated circuit.

These aspects of the present disclosure can offer an AC-voltage sensor circuit, a PFC circuit, and a power supply circuit that are simpler in circuit configuration than before.

### BRIEF DESCRIPTION OF THE DRAWINGS

FIG. 1 illustrates the configuration of a power supply circuit including an AC-voltage sensor circuit according to one preferred embodiment of the present invention.

### DESCRIPTION OF THE EMBODIMENTS

Background and Problem of AC-Voltage Sensor Circuit Used in Power Supply Circuit

Power supply circuits that have been increasingly required to be miniaturized require their sensor circuits to be simplified. In particular, the sensor circuit of a power factor correction (PFC) circuit to which AC voltage is input tends to be complicated unfortunately. This preferred embodiment discloses one example of simplifying an AC-voltage sensor circuit.

For the sake of document simplification, an “AC-voltage sensor circuit ACS1” for instance will be also expressed merely as “ACS1”.

Main Configuration of AC-Voltage Sensor Circuit ACS1 that can Detect AC Voltage Differential

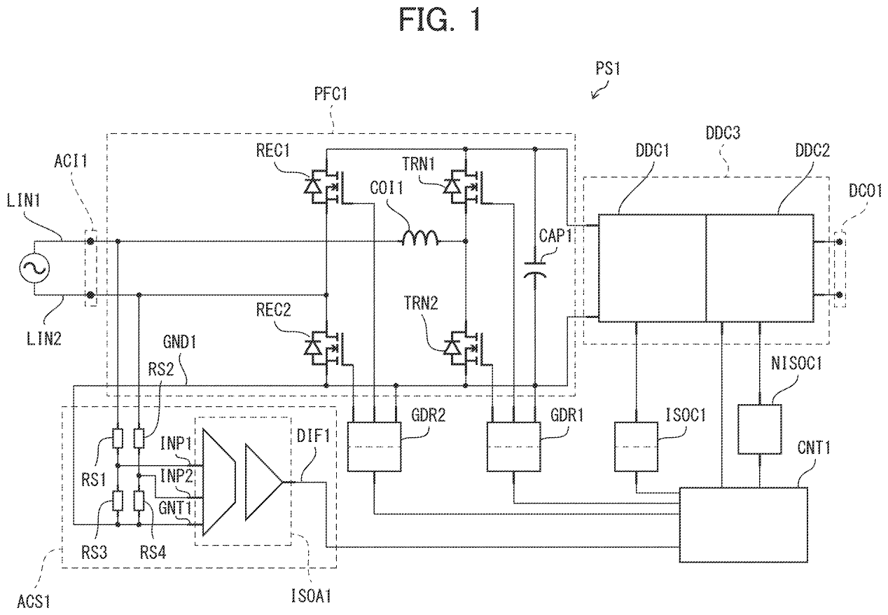

FIG. 1 illustrates the circuit configuration of a power supply circuit PS1 including the AC-voltage sensor circuit ACS1 according to one preferred embodiment of the present invention. FIG. 1 illustrates a PFC circuit PFC1 connected to an AC input unit ACI1, and the AC-voltage sensor circuit ACS1 connected to ACI1. ACI1, which is drawn inside PFC1 via a wire, is included in PFC1 in circuit view (i.e., substantially). As illustrated in the drawing, PS1 includes PFC1, ACS1, a control circuit CNT1, an isolated DC-DC converter DDC3, a direct current (DC) output unit DCO1, a first gate driving circuit GDR1, a second gate driving circuit GDR2, an isolated circuit ISOC1, and a non-isolated circuit NISOC1.

The control circuit CNT1 is a circuit that controls PFC1. The control circuit CNT1 is connected to PFC1 with isolation. In more detail, PFC1 and CNT1 are isolation-connected together by ACS1.

ACS1 includes a sense-signal isolation circuit in order to transmit a sense signal with isolation. Further, ACI1 includes a first line LIN1 and a second line LIN2 each of which is a power supply line. LIN1 and LIN2 are connected to PFC1. PFC1 includes a reference-voltage node GND1.

ACS1 is configured to output a signal indicating the voltage difference between the “voltage of LIN1 for GND1” and the “voltage of LIN2 for GND1”. The signal indicating the voltage difference is input to CNT1. CNT1 includes a microcontroller and can receive an analog signal or digital signal and can output an analog signal or digital signal. The entire power supply circuit PS1 can be thus controlled.

Isolation connection is connection that allows a signal or electric power to be transmitted though electrical connection is not established. Examples include an optical isolation circuit using a photocoupler, an isolated circuit using an electrostatic-capacitance coupling, and a transformer (transformation) circuit using magnetic coupling. These circuits can prevent leakage current, avoid an electric shock, prevent noise propagation and offer other isolation benefits.

ACS1 outputs a signal indicating the difference voltage (differential voltage) between the voltage of LIN1 and the voltage of LIN2. The signal indicating the difference voltage can be transmitted to CNT1 by the sense-signal isolation circuit of ACS1 with isolation. Types of the signal indicating the voltage difference include an analog signal and a digital signal. An example of the digital signal is a delta-sigma modulation signal.

Connection Configuration of AC-Voltage Differential Sensor Including Reference-Voltage Node GND1

As illustrated in FIG. 1, ACS1 includes a first resistor RS1, a second resistor RS2, a third resistor RS3, a fourth resistor RS4, and an isolation amplifier integrated circuit (IC) ISOA1. ISOA1 includes a first signal input terminal INP1, a second signal input terminal INP2, a reference-voltage terminal GNT1, an output terminal DIF1, and the sense-signal isolation circuit.

LIN1 is connected to INP1 via RS1, LIN2 is connected to INP2 via RS2, and GND1 is connected to GNT1. Furthermore, INP1 is connected to GND1 via RS3. INP2 is connected to GND1 via RS4. The voltage of LIN1 can be lowered by RS1 and RS3 and input to INP1. The voltage of LIN2 can be lowered by RS2 and RS4 and input to INP2.

The signal indicating the voltage difference is output from the output terminal DIF1 of ISOA1. ISOA1 adjacent to INP1 and ISOA1 adjacent to DIF1 are electrically isolated. To indicate this isolation, the circuit symbol of ISOA1 illustrated in FIG. 1 is shown separately as two blocks: right and left blocks. Such ISOA1 can detect the difference voltage between LIN1 and LIN2 with reference to GND1. In other words, ACS1 can detect the difference voltage between LIN1 and LIN2 with reference to GND1. An isolation amplifier IC having one signal input terminal uses GNT1 connected to LIN1 or LIN2, and hence, common grounding, which will be described later on, cannot be achieved.

Common Grounding of Isolated Gate Driving Circuit Through Reference-Voltage Node Connection

The first gate driving circuit GDR1 including a drive-signal isolation circuit, and the second gate driving circuit GDR2 including a drive-signal isolation circuit are connected to PFC1. GDR1 and GDR2 are partly connected to GND1. To be more specific, the reference-voltage terminals of GDR1 and GDR2 adjacent to PFC1 are connected to GND1. PFC1 and CNT1 are isolation-connected together by the drive-signal isolation circuit of GDR1 and the drive-signal isolation circuit of GDR2.

GDR1 is connected to transistors, which will be described later on, and GDR2 is connected to rectification elements, which will be described later on. GDR1 and GDR2 are ICs provided with a drive-signal isolation circuit using a photocoupler. The dotted-line symbols within the circuit diagrams of GDR1 and GDR2 in FIG. 1 indicate that the ICs are isolated inside.

In PS1, common-grounding connection is established where all the ICs, i.e., ISOA1, GDR1 and GDR2, are connected to GND1. A power supply (not shown) that is supplied to all the ICs can be a common power supply (not shown) in this case. This can simplify the sensor's circuit configuration including the commonization of a power supply (not shown). Furthermore, all the circuits connecting PFC1 and CNT1 together are provided with an isolated circuit, thus establishing isolation connection between PFC1 and CNT1.

Another method is connecting GNT1 of ISOA1 to LIN1 or LIN2 to detect AC voltage. The circuit configuration including ACS1 is unfortunately complicated in this case because common grounding between the ground terminals of respective GDR1 and GDR2 is difficult.

Connection Configuration Between TP-PFC Circuit and AC-Voltage Sensor Circuit

As illustrated in FIG. 1, PFC1 includes ACI1, a first rectification element REC1, a second rectification element REC2, a coil COI1, a first transistor TRN1, a second transistor TRN2, and an output capacitor CAP1. The negative electrode of CAP1 is connected to GND1. The series circuit of TRN1 and TRN2 is connected in parallel to CAP1. The connection node between TRN1 and TRN2 is connected to LIN1 via COI1. The series circuit of REC1 and REC2 is connected in parallel to CAP1. The connection node between REC1 and REC2 is connected to LIN2. Such a circuit is called a totem pole (TP)-PFC circuit.

TRN1 or TRN2 is connected to GDR1. FIG. 1 illustrates, by way of example only, a circuit configuration where TRN1 and TRN2 are both connected to GDR1. At least one of TRN1 and TRN2 needs to be connected to GDR1. CNT1 drives TRN1 or TRN2 via GDR1. REC1 or REC2 is connected to GDR2. FIG. 1 illustrates, by way of example only, a circuit configuration where REC1 and REC2 are both connected to GDR2. At least one of REC1 and REC2 needs to be connected to GDR2. CNT1 drives REC1 or REC2 via GDR2.

CNT1 can drive two transistors via GDR1. A single transistor and a single gate driving circuit may be connected on a one-to-one basis by increasing the number of gate driving circuits.

The TP-PFC circuit performs a circuit operation where the voltage of LIN1 and the voltage of LIN2 do not both coincide with GND1. Hence, the differential voltage between LIN1 and LIN2 needs to be detected in order to detect AC input voltage accurately. However, the commonization of a power supply (not shown) is unfortunately difficult in a conventional differential-voltage detecting circuit because it is difficult to connect the AC voltage sensor to the reference-voltage node. Using ACS1 according to the present disclosure can solve this problem.

Connection Configuration Between TP-PFC Circuit, DC-DC Converter and AC-Voltage Sensor Circuit

As illustrated in FIG. 1, DDC3 includes a primary circuit DDC1 and a secondary circuit DDC2. ACI1, PFC1, DDC1, DDC2, and DCO1 are input to PS1 sequentially from the input of its power supply toward the output of the same. DDC1, connected to PFC1, is connected to CNT1 via ISOC1. DDC2 is connected to CNT1 via NISOC1.

DDC1 and DDC2 are isolated by a transformer. PFC1 is non-isolation-connected to DDC1. DDC2 is isolation-connected to PFC1. CNT1 is isolation-connected to PFC1. DDC1 is controlled by CNT1 via the isolated circuit ISOC1. In contrast, DDC2 is connected to CNT1 via the non-isolated circuit NISOC1; thus, CNT1 is a secondary circuit as DDC2 is.

Using ACS1 in PS1 having such a circuit configuration enables a differential voltage signal to be transmitted to CNT1 on the secondary side with isolation. Furthermore, DDC2, a secondary circuit, is controlled directly by CNT1 via NISOC1 without isolation. Thus, one CNT1 can control PFC1 and DDC1 on the primary side, and DDC2 on the secondary side. That is, one CNT1 can control entire PS1.

It should be noted that each of the foregoing numeric values is a mere example. It is also noted that to adjust circuit operations, a resistor can be added on a wire in the circuit diagram as appropriate, or a capacitor can be added between wires in the circuit diagram as appropriate.

Additional Note

One aspect of the present disclosure is not limited to the foregoing preferred embodiment. Various modifications can be devised within the scope of the claims. A preferred embodiment that is obtained in combination, as appropriate, with technical means disclosed in respective preferred embodiments is also included in the technical scope of one aspect of the present disclosure. Furthermore, combining the technical means disclosed in the respective preferred embodiments can form a new technical feature.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An AC-voltage sensor circuit connected to an AC input unit of a PFC circuit,
a control circuit and the PFC circuit being isolation-connected,
the AC-voltage sensor circuit comprising a sense-signal isolation circuit,
wherein the PFC circuit and the control circuit are isolation-connected together by the AC-voltage sensor circuit,
the AC input unit includes a first line and a second line that are power supply lines,
the PFC circuit includes a reference-voltage node, and
the AC-voltage sensor circuit is configured to output a signal indicating a voltage difference between a “voltage of the first line for the reference-voltage node” and a “voltage of the second line for the reference-voltage node”.

2. The AC-voltage sensor circuit according to claim 1, comprising an isolation amplifier IC including a first signal input terminal, a second signal input terminal, a reference-voltage terminal and the sense-signal isolation circuit,
wherein the first line is connected to the first signal input terminal via a first resistor,
the second line is connected to the second signal input terminal via a second resistor,
the reference-voltage node is connected to the reference-voltage terminal, and
the isolation amplifier IC is configured to output the signal indicating the voltage difference.

3. A PFC circuit comprising the AC-voltage sensor circuit according to claim 2,
wherein a gate driving circuit including a drive-signal isolation circuit is connected to the PFC circuit,
the gate driving circuit is partly connected to the reference-voltage node, and
the PFC circuit and the control circuit are isolation-connected together by the gate driving circuit.

4. The PFC circuit according to claim 3, comprising: a first transistor; a second transistor; a first rectification element; a second rectification element; an output capacitor; and a coil,
wherein a negative electrode of the output capacitor is connected to the reference-voltage node,
a series circuit of the first transistor and the second transistor is connected in parallel to the output capacitor,
a connection node between the first transistor and the second transistor is connected to the first line via the coil,
a series circuit of the first rectification element and the second rectification element is connected in parallel to the output capacitor,
a connection node between the first rectification element and the second rectification element is connected to the second line,
the first transistor or the second transistor is connected to the gate driving circuit, and
the control circuit is configured to drive the first transistor or the second transistor via the gate driving circuit.

5. A power supply circuit comprising the PFC circuit according to claim 4,
the power supply circuit further comprising: an isolated DC-DC converter; a DC output unit; an isolated circuit; and a non-isolated circuit,
wherein the isolated DC-DC converter includes a primary circuit and a secondary circuit,
the AC input unit, the PFC circuit, the primary circuit, the secondary circuit and the DC output unit are connected sequentially from an input of a power supply of the power supply circuit toward an output of the power supply of the power supply circuit,
the primary circuit is connected to the control circuit via the isolated circuit, and
the secondary circuit is connected to the control circuit via the non-isolated circuit.
